(19) United States
(12) Patent Application Publication
(10) Pub. No.: US 2005/0165827 A1
(43) Pub. Date: Jul. 28, 2005

(54) Systems and methods for customizing objects

(76) Inventor: Winfried Schmitt, Walldorf (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/854,170

(22) Filed: May 27, 2004

(30) Foreign Application Priority Data
May 28, 2003 (EP) 03012033.1

(51) Int. Cl. G06F 17/00; G06F 17/24

(52) U.S. Cl. 707/102; 707/100; 715/517; 715/527

(57) ABSTRACT

Systems and methods are provided for customizing objects, such as customization objects. Such systems and methods may include displaying names of one or more predefined parameter sets for a customization object which have been entered previously, displaying a first entry field for entering a name of an additional parameter set for the customization object, and displaying one or more second entry fields for entering the additional parameter set. With the disclosed systems and methods, a user may perform the customization either by selecting one of the names of the predefined parameter sets, or by entering an additional parameter set. In the later case, the user may have the option to enter a name for the additional parameter set.

### BACKGROUND OF THE INVENTION

1. Field of the Invention

The present invention generally relates to the field of data processing and systems and methods for customizing objects. More particularly, and without limitation, the invention relates to systems and more for customizing objects including, for example, customization objects.

2. Background Information

Computer systems typically include operating system software that controls the basic function of the computer, and one or more software application programs that run under the control of the operating system to perform desired tasks. As the capabilities of computer systems have increased, the application programs designed for these high performance systems have become more powerful. Additionally, application program development costs have continued to rise because of the ever-increasing complexity of these programs.

One way in which the performance of application software programs has been improved, while the associated development costs have been limited, is by using object-oriented programming concepts. The goal of using object-oriented programming is to create small, reusable sections of program code known as “objects” that can be quickly and easily combined and re-used to create new programs. The modular and re-usable aspects of objects will typically speed development of new programs, thereby reducing the costs associated with the development cycle. In addition, by creating and re-using a group of well-tested objects, a more stable, uniform, and consistent approach to developing new computer programs can be achieved.

Object-oriented technology is also used to enable customization for application programs. An application program can be based on one or more customizing objects. A user can create an instance of the customizing object of an application program by entering a set of parameters. Such a parameter set is also referred to as “customizing setting” or “user preferences”.

For example, before customers can run an SAP® R/3 system, several system parameters must be set for customizing of the applications. The parameter sets of the customizing are stored in database tables.

Complex application programs can have more than hundred customizing objects for customizing various functionalities, such as printing, communication, email filtering, or for specifying a group of companies with whom business transactions can be performed.

In view of the many customizing objects used by complex application programs, there is a need to provide an improved systems and methods for customizing.

### SUMMARY OF THE INVENTION

Embodiments consistent with the invention provide improved systems and methods for customizing objects. In accordance with one embodiment, a method is provided for customizing a customization object for an application program. A user may be given two different options for specifying a parameter set for the customizing, such as: (i) the user can specify the parameter set by making reference to a parameter set which has been entered in a previous customization; or (ii) the user can enter an additional parameter set, if none of the previously entered parameter sets fits the particular purpose.

In case (ii), the user may have the further option to assign a name to the additional parameter set, such that reference can be made to the additional parameter set in a subsequent customization.

This has the advantage that identical parameter sets which are used for instantiating the same customization object for various application programs need only be entered once. When a user needs to instantiate the customization object for a given application program, he or she only needs to select the name of the previously entered parameter set rather than re-entering the parameter set.

On the other hand, the user is not restricted to use pre-defined parameter sets. On the contrary, the user is free to enter a special parameter set if none of the previously entered parameter sets fit the intended purpose. In case a specific parameter set serves a very special purpose, the user can decide not to assign a name to the specific parameter set. If the user intends to re-use the parameter set in a subsequent customization of the customization object for another application program, the user can enter a name for the parameter set such that the parameter set can be selected by making reference to its name in a subsequent customization.

In accordance with an embodiment, a database table may be stored for each customization object of a set of customization objects. The database table of a customization object may contain a number of parameter sets. Further, each one of the parameter sets may create an instance of the customization object.

In accordance with another embodiment, a key may be assigned to each one of the parameter sets for retrieval of the parameter set in the database table. Further, there may be a mapping table for each one of the application programs which maps customization objects used by the application to keys of parameter sets. This way an application program, which requires access to an instance of a customization object, can access the corresponding parameter set stored in the database table through the mapping table by looking up the key that is assigned to the customization object. As disclosed herein, a global unique identifier (GUID) may be generated as a key for each parameter set.

The names which a user has assigned to some of the parameter sets can also be stored in the database tables. When a user selects a parameter set for customization by making reference to its name, it is not necessary that the parameter set is duplicated. The key which is assigned to the parameter set may be stored in the mapping table of the corresponding application program. As a consequence, multiple application programs can reference the same parameter set through their respective mapping tables.

In accordance with a further embodiment, the customization objects may form the basis for generating of dialogue windows or dialogue boxes. A dialogue window of a customization object has a display field for displaying the names of parameter sets which have been entered previously, if any. The list of names can be shown in a pull-down menu or the like.

Further, the dialogue window may have an entry field for entering a new name of an additional parameter set which the user can enter in other entry fields of the dialogue window. This gives the user the option to either select a parameter set by clicking on one of the names in the pull-down menu list or by entering an additional parameter set in the entry fields of the dialogue window. In the latter case, the user can enter a name for the additional parameter set if he or she has the intention to re-use the additional parameter set in a subsequent customization for the same or another application program.

The various embodiments can include and/or exclude different aspects, features and/or advantages, where applicable. In addition, various embodiments can combine one or more aspects or features of other embodiments, where applicable.

It is to be understood that both the foregoing general description and the following detailed description are exemplary and explanatory only and are not restrictive of the invention, as claimed.

### BRIEF DESCRIPTION OF THE DRAWINGS

In the following description, embodiments will be described in greater detail by making reference to the drawings in which:

FIG. 1 is a block diagram of an embodiment of a data processing system consistent with the invention;

FIG. 2 is illustrative of an embodiment of a method consistent with the invention; and

FIG. 3 is illustrative of an example for a dialogue box.

### DETAILED DESCRIPTION

The following detailed description of embodiments of the present invention refers to the accompanying drawings. Where appropriate, the same reference numbers in different drawings refer to the same or similar elements.

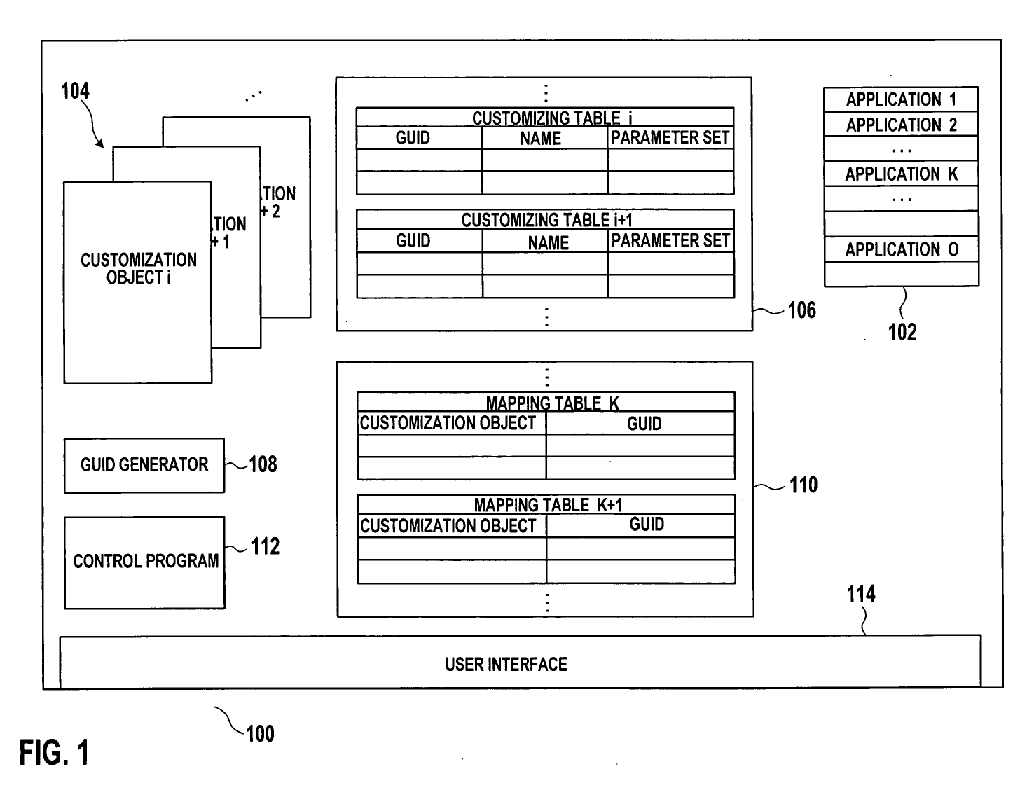

FIG. 1 shows an exemplary data processing system 100, consistent with an embodiment of the invention. As illustrated in the example of FIG. 1, data processing system 100 includes a set 102 of application programs, i.e., application 1, application 2, . . . application k, . . . application o. The application programs of set 102 use a set 104 of m customization objects, i.e., customization object 1, customization object 2, . . . customization object i, . . . customization object m. Each one of the application programs of set 102 uses at least a sub-set of set 104 of the customization objects.

Data processing system 100 may include a storage area 106 for storing one or more database tables for the customization objects of set 104. For each customization object i, there may be a corresponding customizing table i in which alternative parameter sets for instantiating customization object i are stored. By way of example, FIG. 1 shows customizing table i for customization object i and customizing table i+1 for customization object i+1.

In accordance with one embodiment, each parameter set stored in the database tables of storage area 106 may have a key. In the example considered here, the key is a global unique identifier (GUID) which has been generated by GUID generator 108. In addition, a name can be entered for a parameter set in a customizing table of storage area 106. Entering a name is, however, optional.

Further, data processing system 100 has storage area 110 for storage of mapping tables. In storage area 110, a mapping table may be stored for each one of the application programs of set 102. By way of example, mapping table k of application program k and mapping table k+1 of application program k+1 are shown in FIG. 1.

Mapping table k may have an entry for each customization object of the sub-set of set 104 used by application program k. Each customization object of this sub-set is related to a key, which is a GUID in the example considered here. The GUID is used as a key in order to retrieve a parameter set from one of the customizing tables having the same GUID as entered in the mapping table k.

Likewise mapping table k+1 may have an entry for each one of the customization objects of the sub-set of set 104 of customization objects used by application program k+1. Again, the GUIDs entered for the individual customization objects in mapping table k+1 may be used as keys for retrieval of the corresponding parameter sets in the customizing tables of storage area 106.

Further, data processing system 100 may include a control program 112 which can be a part of the operating system of data processing system 100. Control program 112 manages the communication between the application programs of set 102 and the customizing tables and the mapping tables.

By means of user interface 114, a user can perform the customizing and work with the application programs.

In operation, the user selects one of the application programs of set 102. In the selected one of the application programs, the user, for example, opens a dialogue box for customizing one of the customization objects of the sub-set of set 104 used by the selected one of the applications. The user can enter a parameter set in the dialogue window for instantiating the customization object. The parameter set may be stored in the customizing table of the customization object and a key may be assigned to the parameter set by GUID generator 108. As an option, the user may enter a name for the parameter set in the dialogue box, which is also stored in the customizing table.

The key assigned to the parameter set may be stored in the mapping table of the selected one of the application programs in conjunction with the customization object.

Alternatively, the user may perform the customizing by re-using previously entered parameter sets that have been named by the user. For this purpose, a list of the names stored in the customizing table being assigned to the customizing object is displayed. The user may select one of the names in order to specify the corresponding parameter set as an instance of the customization object. In this case, the user does not need to enter the parameter set, but, instead, the key being assigned to the parameter set may be entered by the control program 112 in the mapping table of the selected one of the applications in conjunction with the customization object.

When an application program is executed by data processing system 100, the application program might require usage of one of its customization objects. In this case, the application program performs a look-up operation in its mapping table in order to determine the GUID being assigned to the required customization object. The GUID is used as a key for retrieval of the parameter set, which has been assigned to the GUID. This parameter set may be used by the application program as an instance of the required customization object.

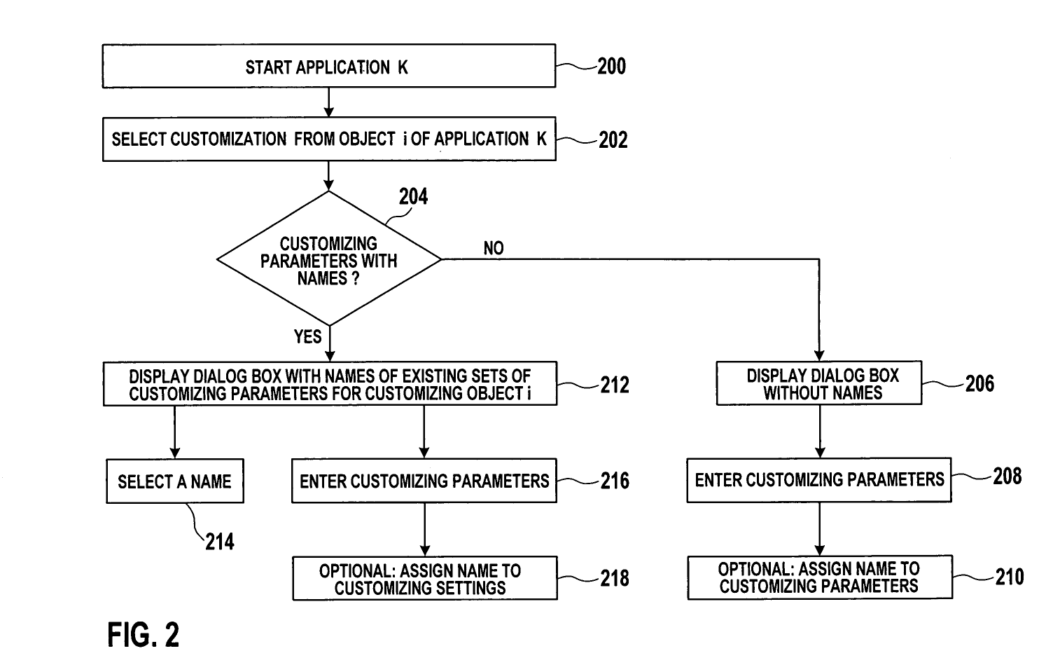

FIG. 2 shows a flow chart of an exemplary method, consistent with an embodiment of the invention. The exemplary method of FIG. 2 may be used in combination with, for example, the data processing system 100 of FIG. 1.

In stage 200, application program k is started by the user. In stage 202, the user may open a dialogue window for customizing of customization object i, which is used by the application program k. Typically, this is done by selecting a corresponding item from an action bar of application program k which opens the dialogue box.

In stage 204, it is determined whether there are named parameter sets in customizing table i of customization object i. If this is not the case, control goes to stage 206 where the dialogue box is displayed without names of previously entered parameter sets. In stage 208, the user may enter a customizing parameter set in the corresponding entry fields of the dialogue box. In response, a key may be generated for the additional parameter set and the parameter set may be stored in the customizing table i in conjunction with the key.

Further, the user can enter a name for the additional parameter set in stage 210. If the user decides to do so the name is also stored in customizing table i in conjunction with the key and the parameter set entered in stage 208.

If it is determined in stage 204 that there are named parameter sets in customizing table I, then the control goes to stage 212, rather than to stage 206. In stage 212, the dialogue box may be displayed with the names of the previously entered parameter sets stored in customizing table i of customization object i. Now the user may be given two options for the customizing:
(i) The user can select one of the names in stage 214. By selecting a particular name, the user selects the previously stored parameter set being assigned to this name for customizing of the customizing object i for application program k.
(ii) If the user decides that none of the named previously entered parameter sets stored in customizing table i are appropriate for the customizing for application program k, then the user may enter an additional parameter set in stage 216. In response, a GUID may be generated for the additional parameter set and the parameter set may be stored in customizing table i in conjunction with the GUID as an additional entry. In stage 218, the user may optionally assign a name to the additional parameter set. If the user decides to do so, the name may also be stored in customizing table i in conjunction with the parameter set entered in stage 216.

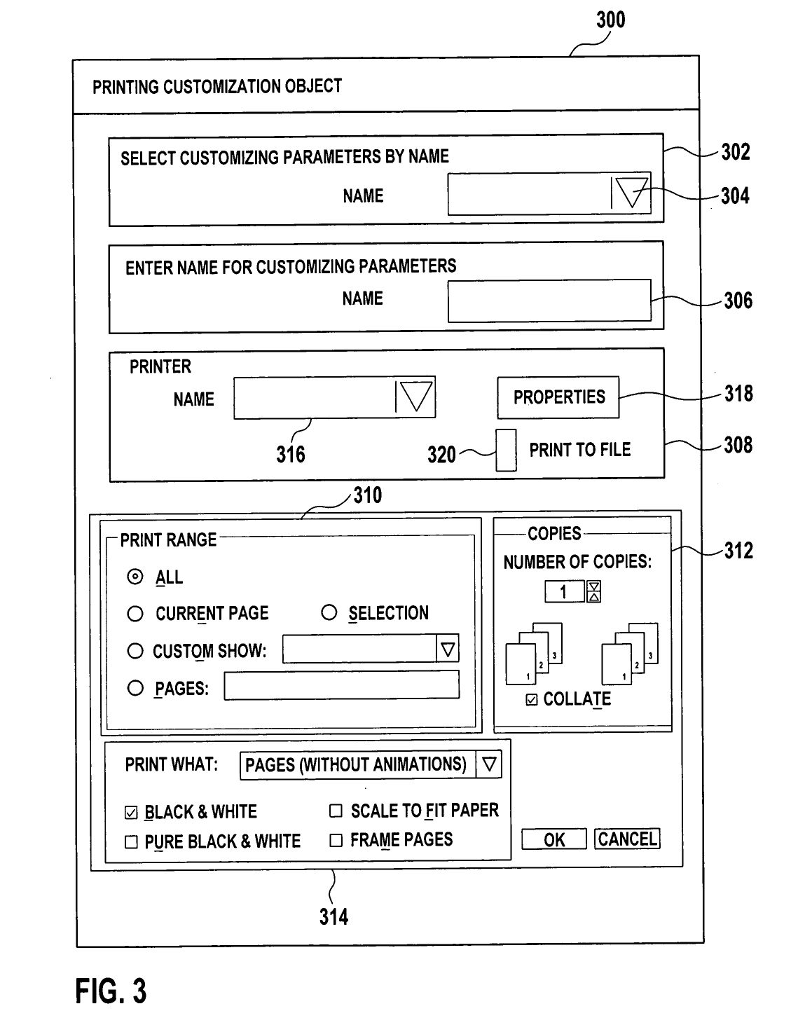

FIG. 3 shows an example of a dialogue box 300, consistent with an embodiment of the invention. In the example of FIG. 3, dialogue box 300 is a representation of a customization object for printing.

Dialogue box 300 has pull-down menu 302 which may only be shown if there are named parameter sets in the customizing table of the printing customization object. If there are such named parameter sets, the user gets a list of the names by clicking on arrow 304. By clicking on one of the names of the list, the user can perform the customizing.

Further, dialogue box 300 may have entry field 306 for entering a name of an additional parameter set that can be entered or defined by a user in entry fields 308, 310, 312 and 314. Entry field 308 may have a pull-down menu 316 for selecting a printer and a button 318 that can invoke a sub-dialogue for specifying the properties of the selected printer. Further ,entry field 308 may have a selection box 320 which enables the user to select “print to file”.

Entry field 310 may be used to enter the print range. Entry field 312 may serve to specify the number of copies to be printed and entry field 314 may serve to specify what is to be printed and further printing parameters, such as “black and white,” or “scale to fit paper.”

If there are named parameter sets for the printing customization object which have been previously entered for other application programs, a list of the names may be shown in pull-down menu 302, which enables the user to select one of the names for the customizing. If the user decides that none of the named parameter sets of pull-down menu 302 is/are appropriate, he or she can enter an additional parameter set by means of entry fields 308, 310, 312, and 314. As an option, the user can enter a name for the additional parameters set in entry field 306.

When the user clicks on the “OK”-button of the dialogue box 300, the additional parameter set which has been entered in entry fields 308, 310, 312, and 314 may be stored in the customizing table of the printing customization object and a key for the additional parameter set may be generated and stored in conjunction with the additional parameter set for later retrieval. If a name has been entered in entry field 306, the name may also be stored in conjunction with the additional parameter set in the customizing table of printing customization object.

When the user has entered an additional parameter set and a name for the additional parameter set, this enables re-use of the additional parameter set in a subsequent customizing of printing customization object. For example, when dialogue box 300 is opened the next time, the name which has been given to the additional parameter set by the user shows up in pull-down menu 302 and can be selected in the subsequent customizing for another one of the application programs.

Consistent with an embodiment of the invention, pull down menu 302 and entry field 306 may be merged into a single display/entry field. In this case, the names are displayed in the same field into which the user can optionally enter a new name for an additional parameter set.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and flow charts of this invention are within the skill of an experienced developer. The various programs or program modules can be created using any of the techniques known to one skilled in the art or can be designed in connection with existing software. For example, programs or program modules can be designed in or by means of Java, C++, HTML, XML, or HTML with included Java applets or in SAP R/3 or ABAP. One or more of such modules can be integrated in existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

Accordingly, other embodiments of the invention will be apparent to those skilled in the art from consideration of the specification and practice of the invention disclosed herein. It is therefore intended that the specification and examples be considered as exemplary only, with a true scope and spirit of the invention being indicated by the following claims.

1. A method of customizing a customization object for an application program, the method comprising:
displaying names of one or more predefined parameter sets for the customization object which have been entered previously;
displaying a first entry field for entering a name of an additional parameter set for the customization object;
displaying a second entry field for entering the additional parameter set; and
enabling a user to perform the customization by selecting one of the names of the predefined parameter sets or by entering the additional parameter set, wherein the user has the option to enter a name for the additional parameter set.

2. The method of claim 1, wherein a plurality of application programs use a common set of customization objects.

3. The method of claim 1, further comprising performing a query on a database for determining the names of the one or more predefined parameter sets for the customization object.

4. The method of claim 3, wherein the database comprises a table for each customization object for storing parameter sets of a customization object.

5. The method of claim 1, wherein each parameter set has a key and each application program has a mapping table for mapping of customization objects to keys.

6. The method of claim 5, further comprising entering the key of a predefined parameter set into the mapping table, if the name of the predefined parameter set is selected by the user.

7. The method of claim 5, whereby the key is a global unique identifier.

8. A computer program product, stored on a digital storage medium, for customizing a customization object for an application program, the computer program product comprising program means for performing the method comprising:
displaying names of one or more predefined parameter sets for the customization objects which have been entered previously;
displaying a first entry field for entering a name of an additional parameter set for the customization object;
displaying one or more second entry fields for entering the additional parameter sets; and
enabling a user to perform the customization by entering a selection of one of the names of the predefined parameter sets, or by entering the additional parameter set in the second entry fields, wherein the user is given the option to enter a name for the additional parameter set.

9. The computer program product of claim 8, the program means being adapted to perform a database query for determining the names of the one or more predefined parameter sets.

10. The computer program product of claim 8, the program means being adapted to store the additional parameter set in a table being assigned to the customization object.

11. The computer program product of claim 8, the program means being adapted to generate a key for the additional parameter set and for entering the key in a mapping table relating the customization object of the application program to the key for retrieval of the parameter set being assigned to the key.

12. The computer program product of claim 11, the program means being adapted to enter the key being assigned to a predefined parameter set which has been selected in the mapping table.

13. A data processing system, comprising:
a set of customization objects for a number of application programs; and
means for storing parameter sets for each customization object, each parameter set being assigned to one or more of the application programs, and one or more of the parameter sets having assigned names for usage as a reference for entering of an additional customization.

14. The data processing system of claim 13, further comprising a mapping table for each one of the application programs, each mapping table assigning parameter sets to customization objects of an application program.

15. The data processing system of claim 13, further comprising means for generating global unique identifiers, and means for assigning global unique identifiers to the parameter sets as keys.

16. The data processing system of claim 13, further comprising a graphical user interface for displaying a dialogue window, the dialogue window displaying at least one of the names of parameter sets, a first entry field for entering a name of an additional parameter set for a customization object, and a second entry field for entering the additional parameter set.
